(19) United States
(12) Patent Application Publication
(10) Pub. No.: US 2026/0118504 A1
(43) Pub. Date: Apr. 30, 2026

(54) Method and Apparatus for Synthetic Aperture Radar Scanning by a Mobile Communication Device

(71) Applicant: Telefonaktiebolaget LM Ericsson (publ), Stockholm (SE)

(72) Inventors: Gang Zou, Lund (SE); Henrik Sjöland, Lund (SE); Magnus Sandgren, Staffanstorp (SE); Ashkan Kalantari, Malmö (SE); Andres Reial, Höllviken (SE); Fredrik Dahlgren, Lund (SE); Magnus Olsson, Klagshamn (SE)

(21) Appl. No.: 18/841,423

(22) PCT Filed: Mar. 1, 2022
(86) PCT No.: PCT/EP2022/055110

§ 371 Date: Aug. 26, 2024

(51) Int. Cl. G01S 13/90; G01S 7/00; G01S 7/03

(52) U.S. Cl. CPC G01S 13/90; G01S 7/006; G01S 7/038

(57) ABSTRACT

Disclosed techniques support Synthetic Aperture Radar (SAR) scanning by a mobile communication device (10), based on advantageous reuse of antenna elements (142) included in the device (10) for communication-signal transmission or reception, for full-duplex transmission of radar signals (50) and corresponding reception of reflected return signals (52). Particularly, radar scanning uses respective subsets (144, 146) of antenna elements that are spatially separated within the involved antenna array(s) (14), with beamforming used to reduce interference between the transmitted radar signal (50) and the received return signal (52). SAR scanning enables, for example, a user of the device (10) to detect concealed objects (66), and SAR scanning may advantageously employ a user interface (108) of the device (10) to control SAR scanning or display the results of SAR scanning.

### TECHNICAL FIELD

Disclosed techniques support Synthetic Aperture Radar (SAR) scanning by a mobile communication device, based on advantageous reuse of antenna elements included in the device for communication-signal transmission or reception, for full-duplex transmission of radar signals and corresponding reception of reflected return signals.

### BACKGROUND

Increasing interest attends the use of radar in mobile communication devices. U.S. Pub. 2020/0249341 A1, for example, describes a portable imager that uses radar scanning to detect concealed objects. The imager includes a camera to capture images from different points of view during a radar scan, with the respective images and corresponding accelerometer data used to determine a scan trajectory of the imager, for merging the radar scan data to produce a Synthetic Aperture Radar (SAR) image.

Some devices repurpose communication circuitry for radar sensing, with such repurposing becoming practical as communication-signal frequencies move towards and into the millimeter-wave (mmW) frequencies, such as seen with Fifth Generation (5G) New Radio (NR) networks based on Third Generation Partnership Project (3GPP) specifications. U.S. Pub. 2020/0300996 A1 illustrates an example wherein a portable communications device operates its radio frequency system hardware as a bi-static radar, for detecting proximate objects, such as the body of a human user of the device. Correspondingly, the device controls its output power, e.g., for compliance with limits on maximum exposure or specific absorption rate limits.

U.S. Pub. 2019/0377075 A1 illustrates another example of reuse of certain communication-system elements for radar scanning. Particularly, radar sensing may use the same phased array antenna used by the device for communication-signal beamforming. Radar scanning enables the device to detect nearby objects and correspondingly adapt its beamforming scanning operations for communications, e.g., limit or disable beamforming scanning in the direction(s) obstructed by proximate objects. U.S. Pub. 2021/0103031 A1 also broadly describes the reuse of antenna systems of a portable device, for both communications and radar, albeit with a focus on using radar-sensing for gesture recognition.

Significant challenges remain, however, in achieving good radar performance using circuitry that is shared with and prioritized for communications-signal transmission and reception operations. A particular set of challenges arise in the context of performing SAR scanning with mobile communication devices, based on reuse of the antenna system(s) used for communications-signal transmission and reception.

### SUMMARY

Disclosed techniques support Synthetic Aperture Radar (SAR) scanning by a mobile communication device, based on advantageous reuse of antenna elements included in the device for communication-signal transmission or reception, for full-duplex transmission of radar signals and corresponding reception of reflected return signals. Particularly, radar scanning uses respective subsets of antenna elements that are spatially separated within the involved antenna array or arrays, with beamforming used to reduce interference between the transmitted radar signal and the received return signal. SAR scanning enables, for example, a user of the device to detect concealed objects, and SAR scanning may advantageously employ a user interface of the device to control SAR scanning or display the results of SAR scanning. In particular, SAR scanning using millimeter-wave (mmW) signal frequencies allows for detection of concealed objects with high resolution.

One embodiment comprises a method of operation by a mobile communication device, to support use of the device for performing a SAR scan. The method includes acquiring radar data by performing full-duplex transmission of a radar signal and corresponding reception of a return signal. The acquisition is based on the device transmitting the radar signal from a first subset of antenna elements in an antenna array of the device that is used for communication-signal transmission and reception, and receiving the return signal via a second subset of antenna elements in the same or another antenna array of the device, where the second subset is spatially separated from the first subset. The method also includes the device applying a set of beamforming coefficients for the first or second subset of antenna elements, the beamforming coefficients defining per-element signal weights that create a signal null in a direction of the other subset.

Another embodiment comprises a mobile communication device configured to perform a SAR scan. The device includes communication circuitry and an associated antenna array, and further includes processing circuitry that is operatively associated with the communication circuitry. The processing circuitry is operative to acquire radar data by performing full-duplex transmission of a radar signal and corresponding reception of a return signal. To carry out the radar-data acquisition, the processing circuitry is configured to: transmit the radar signal from a first subset of antenna elements in an antenna array of the device that is used for communication-signal transmission and reception; receive the return signal via a second subset of antenna elements in the same or another antenna array of the device, where the second subset is spatially separated from the first subset; and apply a set of beamforming coefficients for the first or second subset of antenna elements, the beamforming coefficients defining per-element signal weights that create a signal null in a direction of the other subset.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a mobile communication device shown in context with an example wireless communication network, according to one embodiment.

FIG. 2 is a diagram depicting example use of a mobile communication device to perform a Synthetic Aperture Radar (SAR) scan.

FIG. 3 is another block diagram of a mobile communication device, according to one embodiment.

FIGS. 4 and 5 are block diagrams illustrating example implementation details for a mobile communication device, according to respective embodiments.

FIGS. 6-10 are diagrams of example arrays of antenna elements and corresponding respective subsets of antenna elements used for transmission of a radar signal and reception of a corresponding return signal.

FIG. 11 is a block diagram of example implementation details of an antenna panel of a mobile communication device, according to one embodiment.

FIGS. 12 and 13 are logic flow diagrams of methods of operation by mobile communication device, according to respective embodiments.

### DETAILED DESCRIPTION

Techniques disclosed herein for implementing SAR scanning in a mobile communication device offer the packaging and cost advantages of reusing communications hardware for radar scanning, while also avoiding radar-imaging performance issues that can arise from reusing communications hardware rather than dedicated radar hardware. For example, the techniques according to one or more embodiments include implementation of full-duplex radar scanning for capturing SAR radar image, while using transmit (TX) or receive (RX) beamforming to enhance TX-RX signal isolation within a communications-signal antenna array that is reused for full-duplex radar operations. Such operations allow the mobile device to perform SAR scans with high spatial resolution. Unless otherwise noted or clear from the context, references to “A or B” herein imply any of A alone, B alone, or A and B together.

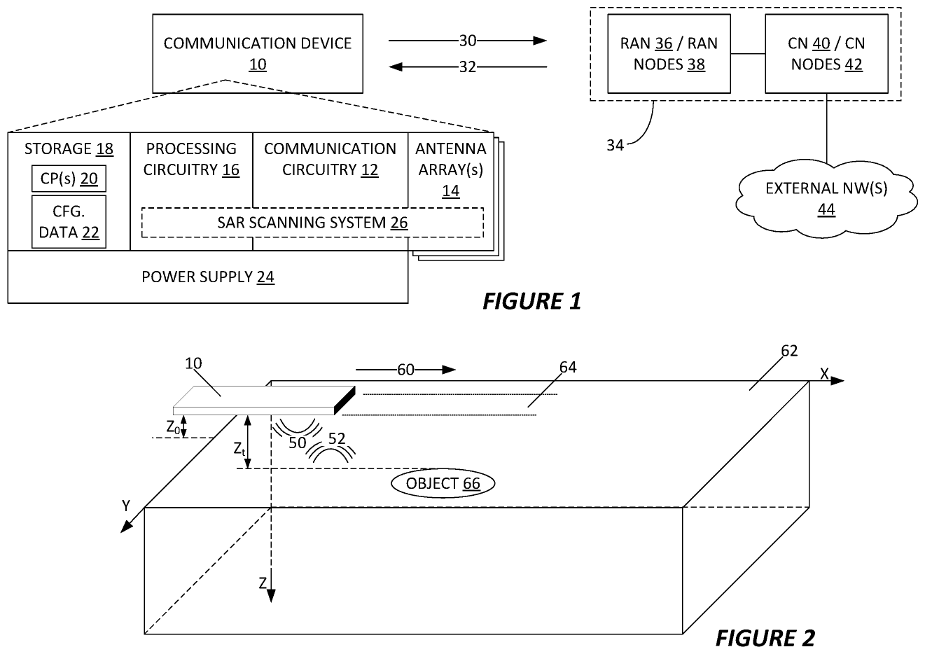

FIG. 1 illustrates a mobile communication device 10 according to an example embodiment, where the mobile communication device 10—hereafter, device 10—is configured to perform a Synthetic Aperture Radar (SAR) scan, based on reusing at least portions of its communication hardware. As an example, the device 10 comprises a smart phone, a tablet computer, smart glasses or other wearable headset, or other type of portable electronic device that incorporates communication hardware.

The device 10 includes communication circuitry 12 and one or more associated antenna arrays 14, along with processing circuitry 16 and storage 18. The storage 18 comprises one or more types of computer-readable media, such as RAM (Random Access Memory) for working memory and FLASH memory for longer term data retention. In at least one embodiment, the storage 18 is used to store one or more computer programs (CPs) 20 and relevant configuration (CFG) data 22.

Further included is a power supply 24 that provides operating power to the various hardware elements of the device 10. As an example, the power supply 24 comprises a rechargeable battery, along with charging-control circuitry, and voltage-regulation circuitry for supplying output power to the device 10.

FIG. 1 also depicts a “SAR scanning system 26” to indicate that the device 10 is configured to perform SAR scans, with SAR scanning involving advantageous reuse of certain communications hardware and corresponding advantageous mitigations that allow such reuse to yield high-resolution radar imaging. In at least one embodiment, the SAR scanning system 26 is implemented based on the processing circuitry 16 carrying out certain control operations that repurpose or otherwise reuse the antenna array(s) 14 and certain elements of the communication circuitry 12 to perform SAR scanning. Thus, in an example embodiment, the SAR scanning system 26 includes elements of the processing circuitry 16, at least a portion of the communication circuitry 12, and the antenna array 14, as repurposed or reused for SAR scanning, rather than communications-signal transmission and reception. As noted, there may be more than one antenna array 14, e.g., the device 10 may include multiple “antenna panels” having different physical orientations, with each such antenna panel comprising a planar array of individual antenna elements that are used by the device 10 for communications-signal beamforming (transmit or receive).

For ease of discussion, however, this disclosure refers to a singular antenna array 14, which the device 10 uses for the transmission of outgoing communication signals 30 and the reception of incoming communication signals 32. In an example embodiment where the device 10 is configured to communicate with a wireless communication network 34, such as a cellular network based on 3GPP specifications, the outgoing communication signals 30 constitute uplink signals targeting the network 34 and the incoming communication signals 32 constitute downlink signals targeting the device 10. Here, “targeting” at least means that the signals in question are logically intended for the indicated target, but does not necessarily mean that they are spatially shaped in a beamforming sense.

The example network 34 includes a radio access network (RAN) 36 that includes one or more RAN nodes 38, such as base stations or other radio access points, to support wireless communications with the device 10. The RAN 36 communicatively couples to a core network (CN) 40 that includes one or more CN nodes 42, e.g., for access and authorization control of the device 10, managing mobility of the device 10 within the RAN 36, and providing data connectivity and routing functions, to carry user traffic between the communication device 10 and one or more external networks 44, such as the Internet.

FIG. 2 illustrates an example SAR scan performed using the device 10, based on the device performing full-duplex transmission of radar signals 50 and corresponding reception of return signals 52. Performance of the SAR scan depends on a machine or a human user moving the device 10 in a scanning direction 60 along a surface 62, such as the surface of a wall or the exterior of a housing or other enclosure. Movement of the device 10 in the scanning direction 60 defines a scan path 64 along the surface 62 and allows the device 10 to detect objects 66 that are concealed below the surface 62, within the interior volume of the wall, box, or other object being scanned.

Of course, limits on the data-acquisition circuitry and the amount of memory available in the device 10 for buffering radar data impose limits on the radar-detection range of the device 10, as does absorption of the material penetrated by the radar signals and, more generally, the effects of path loss, but object-detection capabilities are provided within a defined distance Zₜ, measured perpendicular from the surface of the device 10 associated with transmission of the radar signals 50 and reception of the corresponding return signals 52. The distance Zₜ includes the distance Z₀, which is the height at which the device 10 is held above the surface 62 for the SAR scan.

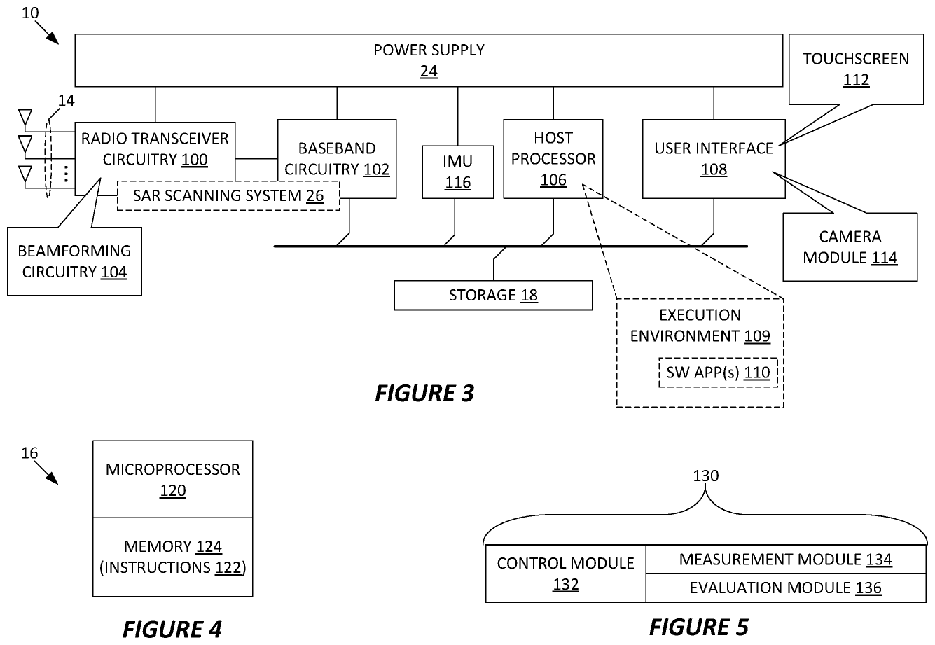

FIG. 3 depicts an example implementation details for the device 10, according to one or more embodiments. The communication circuitry 12 introduced in FIG. 1 is shown in more detail as radio transceiver circuitry 100, with the radio transceiver circuitry 100 comprising radiofrequency (RF) transmission circuitry and RF reception circuitry, e.g., cellular-radio transmitter circuitry and cellular-radio receiver circuitry. Further, the processing circuitry 16 introduced in FIG. 1 is shown in more detail as baseband circuitry 102, where the baseband circuitry 102 is responsible for controlling the radio transceiver circuitry 100 and processing incoming communication signals 32 that are received and down-converted via the radio transceiver circuitry 100, as well as generating and controlling transmit signals for amplification and transmission by the radio transceiver circuitry 100 as outgoing communication signals 30.

Beamforming circuitry 104 is included in the radio transceiver circuitry 100, in the depicted example. The beamforming circuitry 104 is implemented in the digital domain or in the analog domain, or it is implemented using a hybrid approach that includes both analog and digital beamforming. Further, the beamforming circuitry 104 comprises transmit beamforming circuitry or receive beamforming circuitry or both. As will be understood, the beamforming circuitry 104 is operative to apply beamforming weights, which may also be referred to as beamforming coefficients, beamforming factors, antenna weights, etc.

For transmit beamforming, the beamforming circuitry 104 applies per-element antenna weights, such that the same transmit signal is transmitted from respective antenna elements of the antenna array 14 with different phases and, possibly, different amplitudes. The differences in phasing produce patterns of constructive and destructive combining of the transmit signal in the far field, to produce a shaped beam. For receive beamforming, the beamforming circuitry 104 applies per-element antenna weights, such that the antenna array 14 exhibits a corresponding directional sensitivity, meaning that incoming communication signals 32 having a certain directionality relative to the antenna array 14 are received with higher gain.

The example device 10 further includes a host processor 106, which comprises a low-power microprocessor, for example. In one or more embodiments, the processing circuitry 16 introduced in FIG. 1 is considered to include the host processor 106, which provides the device 10 with its overall functionality by providing an execution environment 109 for one or more software applications 110 to run on the device 10. In such embodiments, the SAR scanning system 26 extends into the host processor 106. However, in at least one embodiment the processing circuitry 16 does not include the host processor 106, although it does interact with the host processor 106, e.g., to perform SAR scanning responsive to a user controlling the device 10, based on interacting with the device 10 via a user interface 108 of the device 10.

In at least one embodiment, the user interface 108 of the device 10 includes a touchscreen 112 for receiving user inputs, e.g., touch inputs directed to graphical control elements displayed on the touchscreen 112. The software application(s) 110 that run on the device 10 include, for example, an application that displays touch controls to the user, for starting and stopping SAR scans, viewing SAR scan data, etc. In at least one embodiment, the user interface 108 further includes a camera module 114, and image data obtained via the camera module 114 is used in association with performing SAR scans. Further, in at least one embodiment, the device 10 includes an inertial measurement unit (IMU) 116, with data from the IMU 116 used in association with performing SAR scans.

FIG. 4 illustrates a further example detail for the processing circuitry 16 of the device 10, according to one or more embodiments. In the example of FIG. 4, the processing circuitry 16 comprises one or more microprocessors 120 or other digital processing circuitry that is specially adapted to carry out the SAR-scanning operations disclosed herein, based on the execution of computer program instructions 122 that are stored in a memory 124. The memory 124 can be understood as example circuitry comprised in the storage 18, and it may be integrated with or communicatively coupled to the microprocessor(s) 120.

FIG. 5 illustrates an example implementation of the device 10 in the context of SAR scanning, where the SAR-scanning functionality of the device 10 is implemented via a set 130 of processing units or modules. Here, a processing unit or module comprises a functional or logical circuit having specified functionality and implemented via underlying physical circuitry. In the depicted example, the device 10 comprises a control module 132 that is configured to control SAR-scanning operations, a measurement module 134 that is configured to perform radar-signal measurements—i.e., detect, process, and buffer return-signal data—and an evaluation module 136 that is configured to evaluate the radar signal measurements and generate a corresponding radar image from a SAR scan.

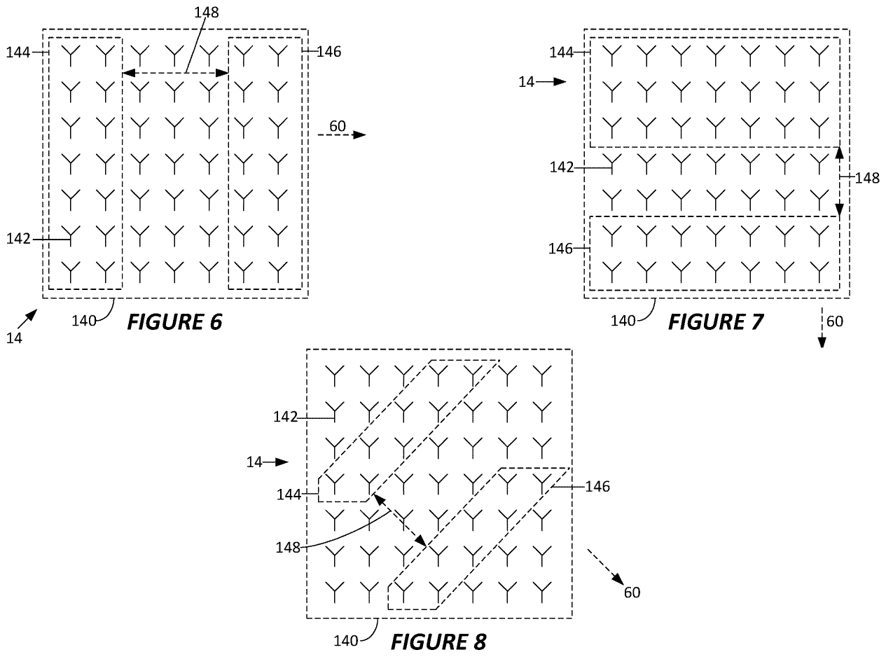

FIGS. 6-8 illustrate advantageous use of an antenna array 14 for SAR scanning. As noted, the antenna array 14 may comprise a panel or other set 140 of antenna elements 142, where each antenna element 142 corresponds to a separate transmit or receive signal chain, for weighted signal transmission or reception in the context of beamforming. To perform full-duplex transmission of the radar signal 50 and corresponding reception of the return signal 52, the device 10 is configured to use a first subset 144 of antenna elements 142 for transmission of the radar signal 50 and use a second subset 146 of antenna elements 142 for reception of the return signal 52. The two subsets 144 and 146 are spatially separated within the overall set 140 of antenna elements 142.

At a minimum, “spatially separated” means that the first and second subsets 144 and 146 are disjoint. Further, in at least one embodiment, “spatially separated” means that there are intervening antenna elements 142 between the first and second subsets 144 and 146, which means that on the feed grid that define the planar arrangement of antenna elements 142 used to form the first and second subsets 144 and 146, there is at least one feed grid position separating the closest respective array elements 142 in the first and second subsets 144 and 146. Put another way, there is at least one inactive antenna element 142 between each antenna element 142 in the first subset 144 and the closest respective antenna element 142 in the second subset 146. “Inactive” means that the antenna element 142 is not used for transmission of the radar signal 50 nor used for reception of the return signal 52. Still further, in at least one embodiment, “spatially separated” means that any antenna element 142 in the first subset 144 is physically separated—in terms of linear distance in the plane of the array—from the closest respective antenna element 142 in the second subset 146 by a distance 148 that is one or more wavelengths of the radar signal 50.

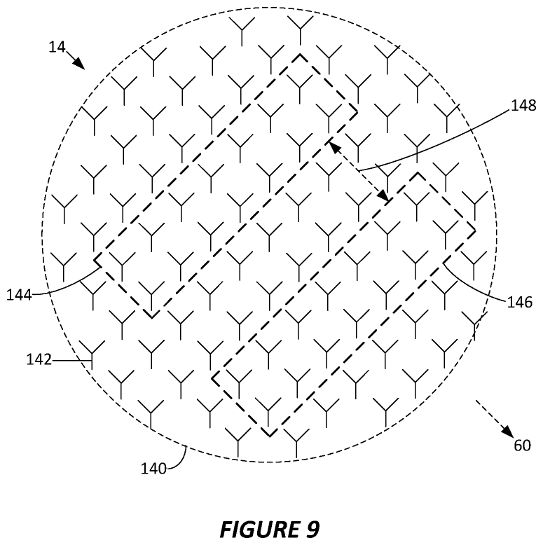

Further, the two subsets 144 and 146 are parallel subsets—in terms of the long axes of the subsets within the plane of the antenna array 14—and, at least nominally, this parallel direction is perpendicular to the scanning direction 60 used for the SAR scanning. Using the terms “horizontal”, “vertical”, and “diagonal” in a sense relevant to the example orientation shown in FIG. 6, the two subsets 144 and 146 run in the vertical direction and are perpendicular to the horizontal scanning direction 60. In FIG. 7, the two subsets 144 and 146 run in the horizontal direction and are perpendicular to the vertical scanning direction 60. In FIG. 8, the two subsets 144 and 146 run diagonally and are perpendicular to the indicated scanning direction. FIG. 9 also depicts diagonal subsets 144 and 146, but illustrates that the two subsets 144 and 146 may be selected from a set 140 of antenna elements 142 that are arrayed in something other than a rectangular pattern.

As a further point regarding spatial separation between the TX subset of antenna elements 142 and the RX subset of antenna elements 142—i.e., the respective subsets of antenna elements 142 used for full-duplex transmission of the radar signal 50 and reception of the return signal 52—the TX subset and the RX subset may be in different antenna arrays 14. That is, in one or more embodiments, the device 10 includes more than one antenna array 14, where the arrays 14 may be oriented in different directions or located at different physical locations within a housing of the device 10, with the antenna elements 142 used to form the TX subset being in one antenna array 14 and the antenna elements 142 used to form the RX subset being in another antenna array 14.

Beyond the advantageous use of spatially-separated subsets 144 and 146 of antenna elements 142 for full-duplex radar operations, the device 10 is configured to apply a set of beamforming coefficients for the first or second subset 144 or 146 of antenna elements 142, where the beamforming coefficients define per-element signal weights that create a signal null in a direction of the other subset 144 or 146. That is, the device 10 performs transmit beamforming of the radar signal 50 or receive beamforming of the return signal 52 or both, to increase the signal isolation between the radar signal 50 and the return signal 52, with the increased isolation improving the quality of the acquired radar data and correspondingly improving the spatial resolution of the SAR radar image obtained during a SAR scan, along with improving the sensing depth Zₜ. The “direction” of one subset 144 (or 146) relative to the other subset 146 (or 144) may be defined in terms of geometric centers of the respective subsets 144 and 146, for example.

With the above example details in mind, a device 10 according to one or more embodiments comprises communication circuitry 12 and an associated antenna array 14, and further comprises processing circuitry 16 that is operatively associated with the communication circuitry 12 and operative to acquire radar data by performing full-duplex transmission of a radar signal 50 and corresponding reception of a return signal 52, based on the processing circuitry 16 being configured to: transmit the radar signal 50 from a first subset 144 of antenna elements 142 in an antenna array 14 of the device 10 that is used for communication-signal transmission and reception; receive the return signal 52 via a second subset 146 of antenna elements 142 in the antenna array 14 that is spatially separated; and apply a set of beamforming coefficients for the first or second subset 144 or 146 of antenna elements 142, the beamforming coefficients defining per-element signal weights that create a signal null in a direction of the other subset 144 or 146. Here, and elsewhere in the disclosure, applying a set of beamforming coefficients for the first or second subset 144 or 146 of antenna elements 142 means beamforming the radar signal 50 or the return signal 52 or both, during the full-duplex transmission and reception.

Performance of the SAR scan depends on the device 10 being moved in a scanning motion, while the device 10 acquires the radar data. A machine moves the device 10, for example, or a user (human) moves the device 10, for performance of the SAR scan.

The processing circuitry 16 is configured to initiate acquisition of the radar data responsive to user input to the device 10, in one or more embodiments. Example user input includes touch input directed to a control icon displayed on a touchscreen 112, or the press of a physical button included in the user interface 108 of the device 10. Other input examples include voice command.

The processing circuitry 16 in one or more embodiments is configured to perform at least one of: suspend a communications mode of the device 10 while acquiring the radar data, or coordinate communication operations by the device 10 with acquiring the radar data. For example, the processing circuitry 16 is configured to operate the device 10 modally, either in a communications mode or a SAR-scanning mode, which may also be referred to as a radar mode. The device 10 may operate in the communications mode by default, and switch to the radar mode responsive to user input or responsive to some other trigger, such as the user orienting or moving the device 10 in a manner characteristic of SAR scanning. Additional signals or information from the camera module 114 or IMU 116 may be used by the processing circuitry 16 to detect the initiation of SAR scanning or to acquire additional information for compensating merging radar data acquired during SAR scanning.

In at least one embodiment, the processing circuitry 16 is configured to begin acquisition of the radar data responsive to one of detecting user input comprising an indication to start the SAR scan or detecting a start of a scanning motion while the device 10 is in a radar-scanning mode. Further, in at least one such embodiment, the processing circuitry 16 is configured to end acquisition of the radar data responsive to one of detecting user input comprising an indication to stop the SAR scan or detecting an end of the scanning motion or reaching a limit on the acquisition of radar data. The processing circuitry 16 in one or more embodiments is configured to output, via a user interface 108 of the device 10, any one or more of: an indication that a radar-scanning mode is active, a prompt to begin moving the device 10 in a scanning direction, or an indication that the acquisition of radar data is active.

Rather than operating in an “either/or” manner wherein the device 10 performs communication operations or performs radar operations on a mutually exclusive basis, the processing circuitry 16 in one or more embodiments is configured to coordinate ongoing communication operations with radar-scanning operations. Such embodiments may involve alternating in a time multiplexing pattern between communication operations and radar operations, or otherwise “scheduling” communications and radar scanning on a cooperative basis.

The first and second subsets 144 and 146 of antenna elements 142 are predefined, in one or more embodiments of the device 10. That predefinition dictates a scanning direction relative to the orientation of the device 10, to be used for performing SAR scans. Pre-defining the first and second subsets 144 and 146 simplifies operation of the device 10, at the expense of reduced flexibility with respect to SAR scanning. In one or more such embodiments, the device 10 is configured to provide a fixed or dynamically-generated indication of the scanning direction 60 to be used for SAR scans. An example of a fixed indication is an arrow embossed or printed on the exterior housing of the device 10, while an example of a dynamically-generated indication is an arrow or other indicator displayed on a touchscreen 112 of the device 10.

In one or more other embodiments, the SAR scanning direction is not predetermined and the processing circuitry 16 is configured to determine a scanning direction 60 of a SAR scan, and select the first and second subsets 144 and 146 of antenna elements 142 based on the scanning direction 60. As explained, in at least one embodiment, the first and second subsets 144 and 146 of antenna elements 142 are respective, parallel linear subsets within the antenna array 14 that are perpendicular to the scanning direction 60 of the device 10. In at least one such embodiment, the processing circuitry 16 is configured to detect the scanning direction 60 based on at least one of: evaluating signals from an IMU 116 included in the device 10, or evaluating images from a camera module 114 included in the device 10. For example, the processing circuitry 16 evaluates one or more live sensing signals from the IMU 116 or live camera images from the camera module 114.

One advantageous aspect of the processing circuitry 16 is that it is configured to apply a set of beamforming coefficients for the first subset 144 or second subset 146 of antenna elements 142, where the beamforming coefficients applied for a respective one of the subsets create a signal null with respect to the other subset. In one embodiment or under one set of operating circumstances, the processing circuitry 16 is configured to apply a set of beamforming coefficients for the first subset 144 of antenna elements 142, to perform transmit beamforming of the radar signal 50, with the transmit beamforming creating a signal null towards the second subset 146 of antenna elements 142. In the same embodiment or under the same or other operating circumstances, the processing circuitry 16 is configured to apply a set of beamforming coefficients for the second subset 146 of antenna elements 142, to perform receive beamforming of the return signal 52, with the receive beamforming creating a signal null towards the first subset 144 of antenna elements 142. The signal null(s) provided by the inter-subset beamforming advantageously increases the TX/RX signal isolation as compared to what is achieved through the use of spatially-separated subsets 144 and 146 of antenna elements 142, for the full-duplex operation.

In at least one embodiment, the set of beamforming coefficients for the first or second subset 144 or 146 of antenna elements 142 are applied in the analog domain, using analog beamforming circuitry 104 included in the communication circuitry 12 of the device 10. Further, in at least one embodiment, the processing circuitry 16 is configured to detect movement jitter of the device 10 during the SAR scan and control beamforming of the radar signal 50 or the return signal 52 to compensate for the detected movement jitter. For example, the processing circuitry 16 performs beamforming of the radar signal 50 to point or orient the radar-signal beam for SAR scanning, and the beamforming vector used for such pointing may be adapted on-the-fly during the scan responsive to changes in an accelerometer signal or orientation signal output by the IMU 116 during the SAR scan.

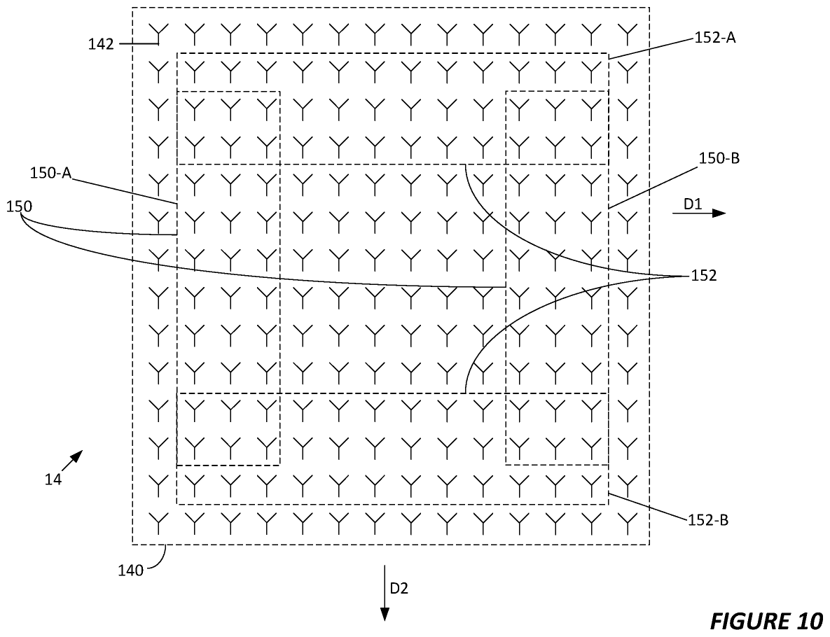

FIG. 10 depicts example details for one embodiment of the processing circuitry 16, wherein, to acquire the radar data, the processing circuitry 16 is configured to select a first candidate pairing 150 of parallel subsets of antenna elements 142 running in a first direction within the antenna array 14, select a second candidate pairing 152 of parallel subsets of antenna elements 142 running in a perpendicular second direction within the antenna array 14, and alternate between use of the first and second candidate pairings 150 and 152, for the full-duplex transmission of the radar signal 50 and the corresponding reception of the return signal 52, to obtain respective first and second sets of radar data. Correspondingly, the processing circuitry 16 is configured to choose which set of radar data to use as the results of the SAR scan, based on comparing the respective sets of radar data. Here, use of the first and second candidate pairings 150 and 152 includes applying respective sets of beamforming coefficients for creating signal nulls between the respective subsets of antenna elements 142 in each candidate pairing 150 and 152.

For example, the device 10 supports two different scanning directions 60, such as directions D1 and D2 suggested in the illustration. Rather than sensing which scanning direction 60 is used to perform a SAR scan, the device 10 acquires radar data using a first candidate pairing 150 of parallel subsets of antenna elements 142 that are perpendicular to a first defined scanning direction and, during the same scan, acquires radar data using a second candidate pairing 152 of parallel subsets of antenna elements 142 that are perpendicular to a second defined scanning direction. Evaluation of the radar data acquired using the first candidate pairing 150 versus the second candidate pairing 152 reveals which candidate pairing was oriented closest to perpendicular to the scanning direction used for the SAR scan.

Similarly, in at least one embodiment, the device 10 has two or more antenna arrays 14, such as a first antenna panel that is horizontally aligned and a second antenna panel that is vertically aligned. Rather than determining which one of the two antenna panels to use for performing a SAR scan, the device 10 performs the SAR scan using both antenna panels, e.g., alternating between the two panels during the scan, to obtain a radar data set for each panel. Evaluation of the respective radar data sets indicates which antenna panel is at the appropriate orientation for the scanning direction used.

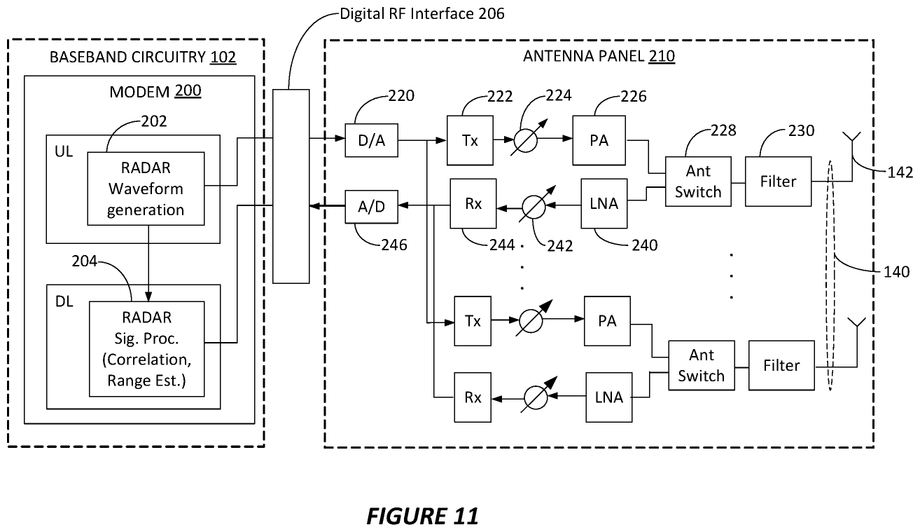

FIG. 11 illustrates example details for a device 10 that is configured to reuse at least a portion of its communications hardware for SAR scanning, according to the disclosed techniques. The earlier-introduced baseband circuitry 102 comprises a modem 200, which includes uplink-signal processing circuitry 202 that, in addition to communication-signal processing, is configured for radar waveform generation—i.e., configured to output or generate a signal that is converted to the analog domain, for amplification, filtering, frequency up-conversion, and transmission by an antenna panel 210 as the radar signal 50. Further included in the modem 200 is downlink-signal processing circuitry 204 that, in addition to communication-signal processing, is configured for processing of the return signal 52, as received through the antenna panel 210.

Here, the antenna panel 210 comprises an integration of the previously introduced communication circuitry 12 and antenna array 14. The device 10 may include more than one antenna panel 210, e.g., multiple antenna panels 210 in different orientations, with each antenna panel 210 including a set or array 140 of antenna elements 142. The communication circuitry carried on each antenna panel includes a transmit signal chain and a received signal chain for each antenna element 142, with these signal chains interfaced to the baseband circuitry 102 via a digital RF interface 206. For full-duplex transmission of the radar signal 50 and corresponding reception of the return signal 52, the TX subset of antenna elements 142 and the RX subset of antenna elements 142 may reside in the same antenna panel 210 or may reside in different antenna panels 210.

Each transmit signal chain in a given antenna panel 210 includes a digital to analog converter (D/A) 220, a mixer/up-converter 222, a phase shifter 224, a power amplifier (PA) 226, an antenna switch 228, and a filter module 230, which couples to a respective antenna element 142. In another example, the phase shifter 224 operates on the local oscillator (LO) signal provided to the mixer/up-converter 222.

The received signal chain associated with the same antenna element 142 includes the filter module 230, the antenna switch 228, a low noise amplifier (LNA) 240, a phase shifter 242, a mixer/down-converter 244, and an analog to digital converter (A/D) 246. In another example, the phase shifter 242 operates on the LO signal provided to the mixer/down-converter 244.

With the illustrated arrangement, each antenna element 142 can be used either as a transmitting element or a receiving element, such that one subset of antenna elements 142 may be used for transmitting the radar signal 50 while another, spatially separated subset of antenna elements 142 may be used for receiving the corresponding return signal 52.

For example, one subset of antenna elements 142 at or near one edge of the set 140 of antenna elements 142 is selected for transmission of the radar signal 50, while another subset at or near the opposite edge of the set 140 of antenna elements 142 is selected for reception of the return signal 52. Selecting respective TX and RX subsets of antenna elements 142 on opposite sides or edges of the same set 140 maximizes the physical separation—spatial isolation—within the set 140. Even greater isolation may be obtained by using separate sets 140 for TX and RX operations, assuming that the device 10 includes two separate sets 140 having relative orientations or locations that are suitable for full-duplex radar operations for SAR scanning.

In an example arrangement, the selected subsets of antenna elements 142 are parallel to one another and the long axes defined by the selected subsets are perpendicular to the scanning direction 60. However, if the scanning direction 60 is not aligned along any axis of the involved set 140, the TX and RX subsets of antenna elements may be selected so that the longer axis of each subset is perpendicular to the dominant component of the scanning direction 60.

SAR scanning needs less beam-steering than would be needed if the device 10 were stationary, because the radar beam emitted by the device 10 is swept by physical movement of the device 10. By selecting rows or columns of antenna elements 142 at opposite sides or edges of the set 140 of antenna elements 142 that are most perpendicular to the scanning direction 60, respectively, it is sufficient to steer the antenna phases differently along the resulting linear arrays formed by the selected TX and RX subsets.

For example, with two rows of antenna elements 142 selected as the TX subset, where corresponding antenna elements 142 in the two rows have the same phases, to create a beam perpendicular (in boresight) to the antenna panel 210 in the movement direction. If the antenna elements 142 have close to a half-wavelength spacing, as is common, there will be a signal null formed at 90 degrees from boresight, i.e. in a direction of the RX subset of antenna elements 142, if both rows of antenna elements 142 in the TX subset are fed the same (phase-aligned) signal. Similarly, the RX subset of antenna elements 142 could use two rows of antenna elements 142 to form a null in a direction of the TX subset. The nulls formed at both receive and transmit side increase the isolation of full-duplex operation, thereby enabling the use of higher transmit power for the radar signal 50. Using two or more rows (or columns) of antenna elements 142 to form the TX subset (and the RX subset) increases the antenna array gain, further improving performance.

The number of rows or columns of antenna elements 142 used to form the TX subset does not have to equal the number of rows or columns of antenna elements 142 used to form the RX subset. Further, if the antenna elements 142 are not arrayed on a half-wavelength spacing, it may be necessary to use an odd number of rows or columns or use rows or columns that are non-adjacent, to create the null at 90 degrees from boresight. It may also be desirable to use varying amplitudes or non-uniform phase increments in different rows or columns within the TX or RX subsets to fine tune the signal cancellation between the TX and RX subsets, to obtain maximum isolation. Similar adjustments may be required if the TX and RX subsets do not lie on the same plane (e.g., on a curved surface or on different antenna panels of the device) or if the SAR scanning beam is not designed to be pointing exactly in boresight.

In one embodiment, the per-row or per-column weights comprising the beamforming coefficients applied are predetermined at design time, assuming a known (e.g., boresight or other) radar beam direction and known antenna element locations. In another embodiment, a calibration step is performed to determine or fine-tune the beamforming coefficients to further reduce the self-interference. The transmit and receive nulls can be tuned separately during the calibration. The TX/RX isolation quality may depend on the calibration complexity, i.e., higher quality requires higher calibration complexity. A compromise used in at least one embodiment is to calibrate for a few beam directions, or just one (boresight) beam direction. If two antenna element rows or columns are used to form the TX subsets, the amplitude and/or phase of the input signal for one row or column of antenna elements 142 in the TX subset is fixed; and the amplitude and/or phase of the input signal at the other row or column is tuned, until a minimum signal is detected for the RX subset of antenna elements 142.

Calibration operations in one or more embodiments further include using a correlator to detect signals delayed by the relatively short time delay within the antenna panel 210, disregarding the energy of any external signal echoes. Different beam directions will then use an amplitude and phase setting between the two rows based on interpolation. If such mitigations do not provide high enough isolation between the TX and RX subsets of antenna elements 142, the number of rows or columns of antenna elements 142 included in one or both the subsets can be increased, e.g., going from two rows or columns to three rows or columns, to improve beamforming operations and yield correspondingly deeper directional nulls as between the TX and RX subsets.

These calibration operations may be performed with long intervals, e.g., at the start of radar operations and then after significant temperature changes. Further, in at least one embodiment, the processing circuitry 16 extends the antenna nulling technique by steering the radar-signal beam along the shorter axis of the TX subset while still maintaining a null direction towards the RX subset of antenna elements 142. In one or more subsets, similar directional nulling is also applied to the RX subset via receive beamforming. There are different ways to achieve the directional nulls between the TX and RX subsets, for example, beam steering with non-uniform phase/amplitude applied to antenna elements.

As noted, the disclosed techniques apply in cases where the TX and RX subsets of antenna elements 142 used for full-duplex transmission of the radar signal 50 and the reception of the return signal 52 reside in the same antenna array 14—e.g., within the same antenna panel 210. However, the techniques also apply in cases where the TX and RX subsets are in different antenna arrays 14—e.g., in different antenna panels 210. For example, the TX radar-signal beam from a first antenna panel 210 of the device 10 can be steered (e.g., by applying phase/amplitude on its antenna elements 142) so that the TX signal null is located in a direction of a second antenna panel 210 of the device 10 that includes the RX subset. In another embodiment, when multiple antenna panels 210 are available, an antenna panel which is located at the null of the TX (or RX) antenna panel 210 can be selected for RX (or TX) use.

The radar-signal frequency is in the mmW spectrum in one or more embodiments, but the disclosed techniques extend to the use of wideband RF signals at other frequencies. Further, the null-steering used to enhance signal isolation between the TX and RX subsets of antenna elements 142 is not limited to SAR scanning and, instead, has applicability in other radar contexts. For example, a traditional beam-scanning radar may apply to enhanced lobe and null steering techniques described above to vary the beam pointing direction for one subset of antenna elements 142 while maintaining a null direction towards the other subset of antenna elements 142. Here, it will be understood that one subset is used for radar-signal transmission and the other subset is used for return-signal reception, in the full-duplex context.

In at least one embodiment, the range of beam sweeping angles is limited compared the full range (+/−90 degrees from boresight). In particular, the limitation is based on the ability to maintain a signal null fixed in the desired direction—i.e., the direction of the other subset—considering the minimum angle of separation limit between the lobe and the null.

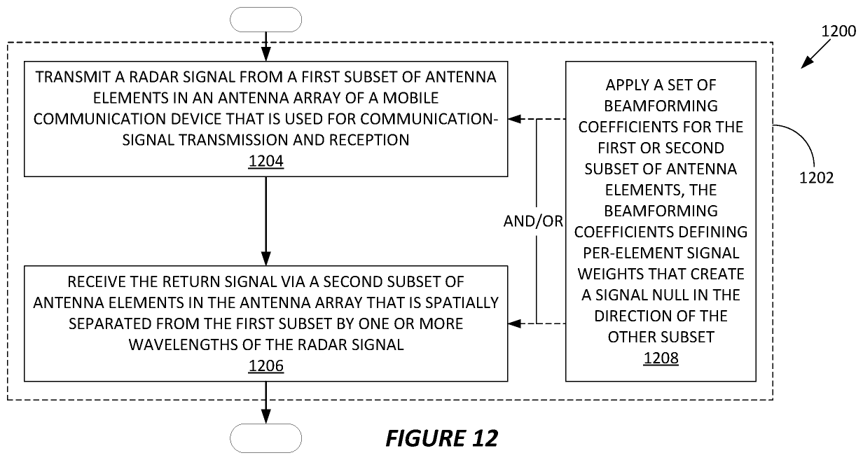

FIG. 12 illustrates an example method 1200 of operation by a device 10, to support use of the device 10 for performing a SAR scan. The method 1200 includes the device 10 acquiring (Block 1202) radar data by performing full-duplex transmission of a radar signal 50 and corresponding reception of a return signal 52, based on: transmitting (Block 1204) the radar signal 50 from a first subset 144 of antenna elements 142 in an antenna array 14 of the device 10 that is used for communication-signal transmission and reception; receiving (Block 1206) the return signal 52 via a second subset 146 of antenna elements 142 in the same or another antenna array 14 of the device 10, where the second subset 146 is spatially separated from the first subset 144, e.g., separated by one or more wavelengths of the radar signal 50; and applying (Block 1208) a set of beamforming coefficients for the first or second subset 144, 146 of antenna elements 142, the beamforming coefficients defining per-element signal weights that create a signal null in a direction of the other subset 144, 146.

The applying step or operation (Block 1208) is performed in concurrence with the full-duplex transmission of the radar signal 50 and reception of the return signal 52. That is, the phrase “applying a set of beamforming coefficients for the first or second subset 144 or 146 of antenna elements 142” means beamforming at least one of radar signal 50 and the return signal 52. The set of beamforming coefficients comprises respective sets of TX and RX beamforming coefficients in cases where beamforming is used for both the radar signal 50 and the return signal 52. Thus, in keeping with the earlier comments about the usage of “or” in this disclosure, the phrase “applying a set of beamforming coefficients for the first or second subset 144, 146 of antenna elements” means applying beamforming coefficients to at least one of the subsets 144 and 146. That is, the method 1200 shall be understood to include at least TX beamforming or at least RX beamforming, and, in at least one embodiment, includes both TX and RX beamforming for forming directional nulls between the respective subsets 144 and 146.

Referring, for a moment, back to the operations described with respect to FIG. 10 and the first and second candidate pairings, it will be appreciated that a SAR scan in one or more embodiments involves the device 10 acquiring two sets of SAR scan data during a SAR scan, based on alternating between first and second candidate pairings 150 and 152 of respective TX and RX subsets of antenna elements 142. That is, at certain times during the scan, the device transmits a radar signal 50 from a first subset 150-A of antenna elements 142 and receives the return signal 52 using a second subset 150-B of antenna elements 142, where the respective subsets 150-A and 150-B constitute the first candidate pairing 150 and are parallel to one another, with their long axes perpendicular to a first direction D1. At other times during the same scan, the device transmits a radar signal 50 from a first subset 152-A of antenna elements 142 and receives the return signal 52 using a second subset 152-B of antenna elements 142, where the respective subsets 152-A and 152-B constitute the second candidate pairing 152 and are parallel to one another, with their long axes perpendicular to a second direction D2 that is perpendicular to the direction D1. The device 10 applies beamforming coefficients to one or both the subsets 150-A and 150-B, for inter-subset nulling, and, likewise, applies beamforming coefficients to one or both the subsets 152-A and 152-B, for inter-subset nulling.

In at least one embodiment or operating scenario, the device 10 does not “know” a priori whether the first candidate pairing 150 or the second candidate pairing 152 is most nearly perpendicular (in terms of long axis) to the actual scanning direction, so it uses both pairings to obtain respective sets of SAR scan data, which the device 10 then evaluates by comparing one or more data metrics to identify and choose the “best” or highest-quality one among the two sets of SAR scan data. Thus, in the context of the method 1200, the operations of Blocks 1204 and 1206 may involve the use of multiple candidate pairings of TX and RX subsets of antenna elements 142, where the “first subset” mentioned in Block 1204 and the “second subset” mentioned in Block 1206 comprise a particular one of the multiple candidate pairings used during the scan—e.g., the candidate pairing that yielded the best performance.

Also, as mentioned earlier, performance of the SAR scan depends on the device 10 being moved in a scanning motion, while the device 10 acquires the radar data. In this regard, the device 10 according to one or more embodiments may be held in the user's hand, with the user moving his/her hand in a sweeping motion/direction. Note that in a handheld context, the user may move the device 10 in a complex way that includes motion components that are parallel to the surface being scanned and motion components that are towards or away from the surface being scanned. More generally, handheld scanning may include motion components that contribute to completion of the SAR scan and motion components that do not contribute and the device 10 accommodates these real-world practicalities. In one or more embodiments, the device 10 may dynamically update the TX and RX subsets of antenna elements used for scanning to select the subset combination that is best suited for the movement direction of the device 10 during the scan.

In another example, the device 10 may comprise a pair of smart glasses or worn device and the user moves his/her head or body to sweep the device 10. In yet another example, the device 10 is mounted or held at least temporarily by a machine that sweeps the device 10.

The method 1200 in one or more embodiments includes the device 10 initiating acquisition of the radar data responsive to user input to the device 10. Further, in one or more embodiments, the method 1200 includes at least one of the device 10 suspending a communications mode of the device 10 while acquiring (Block 1202) the radar data, or coordinating communication operations by the device 10 with acquiring (Block 1202) the radar data.

In at least one embodiment, the method 1200 further comprises the device 10: beginning acquisition of the radar data responsive to one of detecting user input comprising an indication to start the SAR scan or detecting a start of a scanning motion while the device 10 is in a radar-scanning mode; and ending acquisition of the radar data responsive to one of detecting user input comprising an indication to stop the SAR scan or detecting an end of the scanning motion or reaching a limit on the acquisition of radar data.

The method 1200 in one or more embodiments includes outputting, via a user interface 108 of the device 10, any one or more of: an indication that a radar-scanning mode is active, a prompt to begin moving the device 10 in a scanning direction 60, or an indication that the acquisition of radar data is active.

The first and second subsets 144 and 146 of antenna elements 142—i.e., TX and RX subsets, respectively—may be predefined, such that the SAR scanning direction 60 to be used is dictated by the orientation of the predefined subsets. The device 10 may provide a fixed or dynamic indication of the intended SAR scanning direction 60. However, in one or more embodiments, the TX and RX subsets are dynamically selected, e.g., based on an indicated or detected direction of SAR scanning. For example, in at least one embodiment, the method 1200 includes the device 10 selecting the respective, parallel linear subsets to be perpendicular to a scanning direction of the device 10. Selecting parallel linear subsets to be perpendicular to the scanning direction shall be understood in the nominal sense. That is, the subsets often will not in practice be perfectly perpendicular and instead as close to perpendicular as possible, i.e., the deviation from perpendicular being minimized given the configurations available in the antenna arrays and their corresponding antenna sub-array directions.

The perpendicular aspect is of course a natural effect of antenna directivity from the plane of the antenna array. But there is also a noteworthy benefit in the sense that there is a difference in the angular resolution versus the path temporal resolution. With previously known SAR radar capture, typically, only the perpendicular motion has any significant variation over time. With a “handheld” SAR scanner, significant motion can occur in all directions, not only in the projected perpendicular component. Advantageously, the device 10 may dynamically adapt the TX and RX subsets of antenna elements during a SAR scan to account for the user accidentally or deliberately adding more motion along the non-perpendicular axis. In any case, the device 10 may detect the scanning direction based on at least one of: evaluating signals from an IMU 116 included in the device 10 or evaluating images from a camera module 114 included in the device 10.

The method 1200 in one or more embodiments includes the device 10 selecting a first candidate pairing 150 of parallel subsets of antenna elements 142 running in a first direction within the antenna array or arrays 14, selecting a second candidate pairing 152 of parallel subsets of antenna elements 142 running in a perpendicular second direction within the antenna array or arrays 14. With these candidate selections, the device 10 alternates between use of the first and second candidate pairings 15, 152 for the full-duplex transmission of the radar signal 50 and the corresponding reception of the return signal 52, to obtain respective first and second sets of radar data, and choosing which set of radar data to use as the result of the SAR scan, based on comparing the respective sets of radar data.

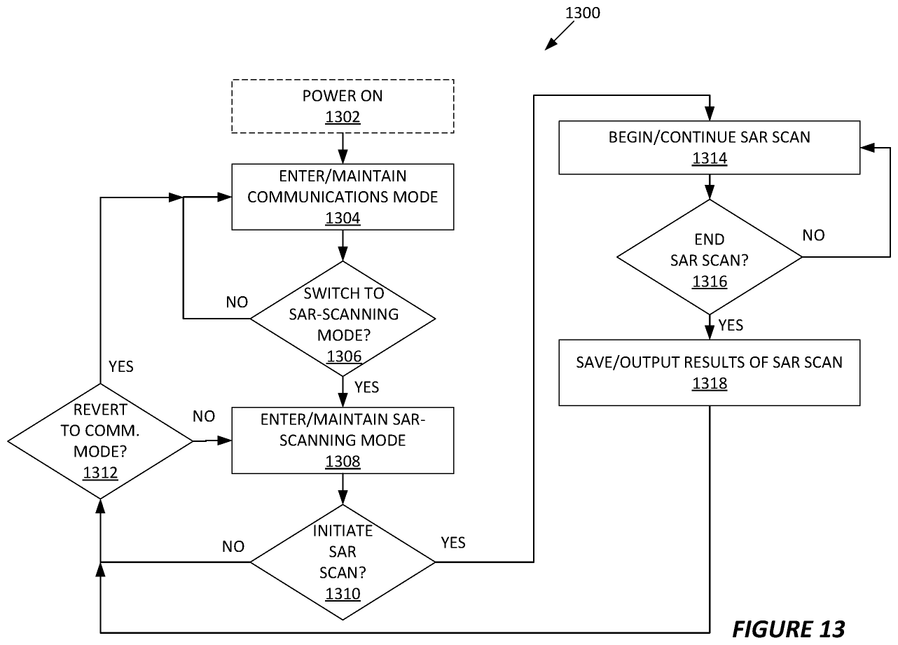

FIG. 13 illustrates another example method 1300 of operation by device 10. The method 1300 may be understood as an example of overall operation of the device 10, with the method 1300 subsuming or including the details of the method 1200, for the performance of SAR scanning operations.

Operations begin with the device 10 powering on or resetting (Block 1302) and entering/maintaining a communications mode (Block 1304) as its default mode of operation. Here, the term “communications mode” refers to operation of the device where it is operative for sending and receiving communication signals and performing other operations, e.g., according to the device configuration, running software applications, etc.

While operating in the communications mode 1304, the device 10 checks whether it should switch to the SAR scanning mode (Block 1306). For example, the device 10 checks whether the user has pressed a soft button or a physical button that initiates the SAR scanning mode. Additionally, or alternatively, the device 10 checks whether the device 10 is oriented and/or moving in a manner that is characteristic for SAR scanning. In the context of such detection, the device 10 may analyze image data acquired via the camera module 114, e.g., to detect orientation, movement, environmental context, etc.

Upon entering the SAR scanning mode (Block 1308), the device determines whether to initiate SAR scanning (Block 1310). For example, the device 10 detects a first input from the user and enters the SAR scanning mode in response, and then initiates SAR scanning—acquisition of radar data—responsive to a second input from the user. Such user control allows the user to position the device 10 or otherwise ready the device 10 for SAR scanning, and then initiate SAR scanning. Alternatively, the device 10 monitors for the beginning of the scanning motion and initiates SAR scanning responsive to detecting such motion.

The device 10 began/maintains the SAR scan (Block 1314) until the scan ends (Block 1316). For example, the device 10 detects the end of a current SAR scan based on cessation of the scanning motion. Additionally, or alternatively, the device 10 uses camera images to detect physical boundaries, such as wall corners or other obstructions and ends the scan upon encountering such an obstruction. Still further, the device 10 in one or more embodiments ends the SAR scan responsive to user input, e.g., a button press. In at least one embodiment, the device 10 is configured to interrupt or temporarily suspend a SAR scan responsive to a communication event, e.g., any communication event or only one or more certain types of communication events.

Upon ending the SAR scan, the device saves or outputs the results of the SAR scan (Block 1318). Additionally, in one or more embodiments, the device 10 outputs intermediate scanning results or at least indicia or other information during the scan to inform the user that SAR scanning is active. The intermediate results can be used to further guide the scan directions and trajectory.

The device 10 checks whether to remain in the SAR scanning mode or revert to the communications mode (Block 1312) and processing proceeds accordingly. However, as noted, in one or more embodiments, the SAR-scanning mode and the communications mode are not mutually exclusive. That is, the device 10 supports SAR scanning in cooperation with communications. As a further point of synergy between the SAR-scanning and communication capabilities of the device 10, in one or more embodiments the device 10 transmits the SAR scanning data via its communication circuitry 12, e.g., to a server or other remote system that is accessible via the wireless communication network 34/external network(s) 44.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-38. (canceled)

39. A method of operation by a mobile communication device, to support use of the device for performing a Synthetic Aperture Radar (SAR) scan, the method comprising:
acquiring radar data by performing full-duplex transmission of a radar signal and corresponding reception of a return signal, based on:
transmitting the radar signal from a first subset of antenna elements in an antenna array of the device that is used for communication-signal transmission and reception;
receiving the return signal via a second subset of antenna elements in the same or another antenna array of the device, the second subset being spatially separated from the first subset; and
applying a set of beamforming coefficients for the first or second subset of antenna elements, the beamforming coefficients defining per-element signal weights that create a signal null in a direction of the other subset.

40. The method according to claim 39, wherein performance of the SAR scan depends on the device being moved in a scanning motion, while the device acquires the radar data.

41. The method according to claim 39, wherein the first and second subsets of antenna elements are predefined, with that predefinition dictating a scanning direction relative to the orientation of the device, to be used for the SAR scan.

42. The method according to claim 41, wherein the device provides a fixed or dynamically-generated indication of the scanning direction to be used for the SAR scan.

43. The method according to claim 39, further comprising determining a scanning direction of the SAR scan and selecting the first and second subsets of antenna elements based on the scanning direction.

44. The method according to claim 39, wherein applying the set of beamforming coefficients comprises applying the set of beamforming coefficients for the first subset of antenna elements, to perform transmit beamforming of the radar signal, the transmit beamforming creating a signal null towards the second subset of antenna elements.

45. The method according to claim 39, wherein applying the set of beamforming coefficients comprises applying the set of beamforming coefficients for the second subset of antenna elements, to perform receive beamforming of the return signal, the receive beamforming creating a signal null towards the first subset of antenna elements.

46. The method according to claim 39, wherein the first and second subsets of antenna elements are respective, parallel linear subsets within the antenna array or arrays.

47. The method according to claim 46, further comprising selecting the respective, parallel linear subsets to be perpendicular to a scanning direction of the device.

48. The method according to claim 47, further comprising detecting the scanning direction based on at least one of: evaluating signals from an inertial measurement unit (IMU) included in the device, or evaluating images from a camera module included in the device.

49. The method according to claim 46, wherein acquiring the radar data includes selecting a first candidate pairing of parallel subsets of antenna elements running in a first direction within the antenna array, selecting a second candidate pairing of parallel subsets of antenna elements running in a perpendicular second direction within the same or another antenna array, and alternating between use of the first and second candidate pairings for the full-duplex transmission of the radar signal and the corresponding reception of the return signal, to obtain respective first and second sets of radar data, and choosing which set of radar data to use as the results of the SAR scan, based on comparing the respective sets of radar data, wherein use of the first and second candidate pairings includes applying respective sets of beamforming coefficients for creating signal nulls between the respective subsets of antenna elements in each candidate pairing, and wherein the first and second subsets comprise the candidate pairing corresponding to the chosen set of radar data.

50. The method according to claim 39, wherein applying the set of beamforming coefficients for the first or second subset of antenna elements comprises applying the set of beamforming coefficients in the analog domain, using analog beamforming circuitry included in the communication circuitry of the device.

51. The method according to claim 39, wherein the first subset of antenna elements is separated from the second subset of antenna elements by at least one wavelength of the radar signal.

52. The method according to claim 39, wherein the first subset of antenna elements and the second subset of antenna elements reside in the first antenna array.

53. A mobile communication device configured to perform a Synthetic Aperture Radar (SAR) scan, the device comprising:
communication circuitry and one or more associated antenna arrays; and
processing circuitry operatively associated with the communication circuitry and operative to acquire radar data by performing full-duplex transmission of a radar signal and corresponding reception of a return signal, based on the processing circuitry being configured to:
transmit the radar signal from a first subset of antenna elements in a first antenna array of the device that is used for communication-signal transmission and reception;
receive the return signal via a second subset of antenna elements in the first or a second antenna array of the device, the second subset being spatially separated of the radar signal; and
apply a set of beamforming coefficients for the first or second subset of antenna elements, the beamforming coefficients defining per-element signal weights that create a signal null in a direction of the other subset.

54. The device according to claim 53, wherein performance of the SAR scan depends on the device being moved in a scanning motion, while the device acquires the radar data.

55. The device according to claim 53, wherein the processing circuitry is configured to initiate acquisition of the radar data responsive to an input to the device.

56. The device according to claim 53 wherein the device is configured to provide a fixed or dynamically-generated indication of the scanning direction to be used for the SAR scan.

57. The device according to claim 53, wherein the processing circuitry is configured to determine a scan direction of the SAR scan, and select the first and second subsets of antenna elements based on the scan direction.

58. The device according to claim 53, wherein the processing circuitry is configured to apply the set of beamforming coefficients for the first subset of antenna elements, to perform transmit beamforming of the radar signal, the transmit beamforming creating a signal null towards the second subset of antenna elements.

59. The device according to claim 53, wherein the processing circuitry is configured to apply the set of beamforming coefficients for the second subset of antenna elements, to perform receive beamforming of the return signal, the receive beamforming creating a signal null towards the first subset of antenna elements.

60. The device according to claim 53, wherein the first and second subsets of antenna elements are respective, parallel linear subsets within the antenna array or arrays.

61. The device according to claim 60, wherein the processing circuitry is configured to select the respective, parallel linear subsets to be perpendicular to a scanning direction of the device.

62. The device according to claim 61, wherein the processing circuitry is configured to detect the scanning direction based on at least one of: evaluating signals from an inertial measurement unit (IMU) included in the device, or evaluating images from a camera module included in the device.

63. The device according to claim 62, wherein, to acquire the radar data, the processing circuitry is configured to select a first candidate pairing of parallel subsets of antenna elements running in a first direction within the antenna array, select a second candidate pairing of parallel subsets of antenna elements running in a perpendicular second direction within the same or another antenna array, and alternate between use of the first and second candidate pairings for the full-duplex transmission of the radar signal and the corresponding reception of the return signal, to obtain respective first and second sets of radar data, and choose which set of radar data to use as the results of the SAR scan, based on comparing the respective sets of radar data, wherein use of the first and second candidate pairings includes applying respective sets of beamforming coefficients for creating signal nulls between the respective subsets of antenna elements in each candidate pairing, and wherein the first and second subsets comprise the candidate pairing corresponding to the chosen set of radar data.

64. The device according to claim 53, wherein the set of beamforming coefficients for the first or second subset of antenna elements is applied in the analog domain, using analog beamforming circuitry included in the communication circuitry of the device.

65. The device according to claim 53, wherein the first subset of antenna elements is separated from the second subset of antenna elements by at least one wavelength of the radar signal.

66. The device according to claim 53, wherein the first subset of antenna elements and the second subset of antenna elements reside in the first antenna array.
